(19) United States
(12) Patent Application Publication
(10) Pub. No.: US 2006/0064717 A1
(43) Pub. Date: Mar. 23, 2006

(54) Information processing device, information processing method and program therefor

(75) Inventors: Toyohiko Shibata, Tokyo (JP); Yasushi Tsuruta, Tokyo (JP); Masatoshi Ohta, Tokyo (JP); Setsushi Minami, Tokyo (JP); Kazuhito Sumiyoshi, Tokyo (JP); Takefumi Kitayama, Kanagawa (JP); Motoki Tsunokawa, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/226,757

(22) Filed: Sep. 14, 2005

(30) Foreign Application Priority Data
Sep. 14, 2004 (JP) P2004-267409

(51) Int. Cl. H04H 9/00; H04N 7/16; G06F 3/00; H04N 5/445

(52) U.S. Cl. 725/37; 725/135; 725/14; 725/9

(57) ABSTRACT

An information processing device and method enable swift extraction of a user's preference. The relevant item evaluation value of the preference is increased based on characteristic information about a moving image content whose replay has been directed, based on characteristic information about a still image content whose replay has been directed, based on characteristic information about a sound content whose replay has been directed, based on information about an executed game content, and based on information about a used network content. The relevant item evaluation value of the preference is decreased based on characteristic information about a deleted content. The invention is applicable to video recorders.

### CROSS-REFERENCE TO RELATED APPLICATIONS

The present application claims priority from Japanese Patent Application No. JP 2004-267409 filed on Sep. 14, 2004, the disclosure of which is hereby incorporated by reference herein.

### BACKGROUND OF THE INVENTION

The present invention relates to an information processing device and a method and program therefor. More specifically, it relates to an information processing device, and a method and program therefor, which are arranged so that users' preferences can be detected, for example, based on operations to contents.

In regard to devices that serve to record a television program, there have been many devices having the functions of: referring to an electronic program guide (EPG) data acquired from broadcast signals, etc.; detecting a broadcast program that can be presumed to agree with a preference of a user; automatically scheduling the program to be recorded; and encouraging the user to watch and listen to the program (see e.g. Japanese Unexamined Patent Application Publication No. JP-A-2004-7757).

As means to extract a preference of a user, there have been the following methods, for example. The first is a method including making the user input a single word of interest. The second is a method including using information in association with a program that the user has already watched and/or listened to, replayed, or deleted (such as the title, genre, cast, and broadcast channel of the program, and others), in response to a user operation to direct watching and/or listening of a program on air, or replay or delete of a recorded program.

In the meantime, nowadays there has been a device having not only the function of recording a television program, but also the functions of: replaying moving and still images recorded on a DVD (Digital Versatile Disc); replaying a musical piece recorded on a CD (Compact Disc), etc.; executing a program recorded on a CD, etc. thereby to work as a game machine; and accessing an arbitrary server through the Internet to browse home pages, for example.

The above-described method to extract users' preferences includes extracting a preference of a user based on user operations to television programs. Therefore, the method has a disadvantage such that it takes a lot of time to extract a preference of a user performing an operation to a television program at a low frequency.

### SUMMARY OF THE INVENTION

It is desirable to enable swift extraction of a preference of a user based on user operations to various kinds of contents.

An information processing device according to an embodiment of the invention includes a detecting section operable to detect an instruction provided by the user to execute at least one of a first content including a moving image, a second content including a still image, a third content including a sound, a fourth content including a computer program, and a fifth content including data downloaded through a network; an acquiring section operable to acquire information on the first to fifth contents according to the instruction detected by the detecting section; and a creating section operable to create information on a user preference based on the information on the first to fifth contents acquired by the acquiring section.

The information processing device further includes a setting section operable to automatically set a recording schedule based on the information on the user preference created by the creating section.

The detecting section is further operable to detect an instruction provided by the user to delete at least one of the first to fifth contents.

When the detecting section detects the delete instruction, the creating section is operable to count down an evaluation value of an item in association with the at least one deleted content and to create the information on the user preference.

When the detecting section detects an instruction provided by the user to watch and/or listen to or replay the at least one of the first to fifth contents, the creating section is operable to add up an evaluation value of an item in association with the at least one content and to create the information on the user preference.

An information processing method according to an embodiment of the invention includes detecting an instruction provided by the user to execute at least one of a first content including a moving image, a second content including a still image, a third content including a sound, a fourth content including a computer program, and a fifth content including data downloaded through a network; acquiring information on the first to fifth contents according to the detected instruction; and creating information on a user preference based on the information on the first to fifth contents.

A recording medium according to an embodiment of the invention is recorded with a computer program for executing an information processing method which detects an instruction provided by the user to execute at least one of a first content including a moving image, a second content including a still image, a third content including a sound, a fourth content including a computer program, and a fifth content including data downloaded through a network; acquiring information on the first to fifth contents according to the detected instruction; and creating information on a user preference based on the information on the first to fifth contents acquired.

In the information processing device, method and program, an instruction provided by the user is detected, the instruction instructing the execution of at least one of a first content including a moving image, a second content including a still image, a third content including a sound, a fourth content including a computer program, and a fifth content including data downloaded through a network; information on the first to fifth contents is acquired according to the detected instruction; and information on a user preference is created based on the acquired information on the first to fifth contents.

The invention enables extraction of a preference of a user. Also, the invention makes it possible to swiftly extract a preference of a user based on user operations to various kinds of contents.

### BRIEF DESCRIPTION OF THE DRAWINGS

FIG. 1 is a block diagram showing an example of arrangement of a video recorder according to an embodiment of the invention;

FIG. 2 is a block diagram showing an example of arrangement of a control section in FIG. 1;

FIG. 3 is a flow chart of assistance in explaining a preference-extracting process by the video recorder;

FIG. 4 is a flow chart of assistance in explaining a storage capacity-securing process by the video recorder;

FIG. 5 is a view of assistance in explaining the outline of a recording schedule-following process by the video recorder;

FIG. 6 is a flow chart of assistance in explaining the recording schedule-following process by the video recorder; and

FIG. 7 is a block diagram showing an example of arrangement of a multipurpose personal computer.

### DETAILED DESCRIPTION

The embodiments of the invention will be described below, in which the correspondences between constitutive requirements cited in claims and concrete examples in the embodiments of the invention are concretely shown as follows. The description is intended to confirm that the concrete examples supporting the invention cited in claims are contained in the embodiments of the invention. Therefore, even when there is a concrete example which is contained in the embodiments of the invention, but not described here as corresponding to the constitutive requirement, that does not mean the concrete example does not correspond to the constitutive requirement. Reversely, even when a concrete example is described here as corresponding to the constitutive requirement, that does not mean the concrete example does not correspond to any constitutive requirement other than that requirement.

Further, the description here does not mean that all the matters corresponding to the concrete examples contained in the embodiments of the invention are stated in Claims. In other words, the description here is for the matters corresponding to the concrete examples contained in the embodiments of the invention, and therefore it does not deny the presence of an invention that is not stated in any Claims hereof and may be applied as a division hereof or added as an amendment hereto in the future.

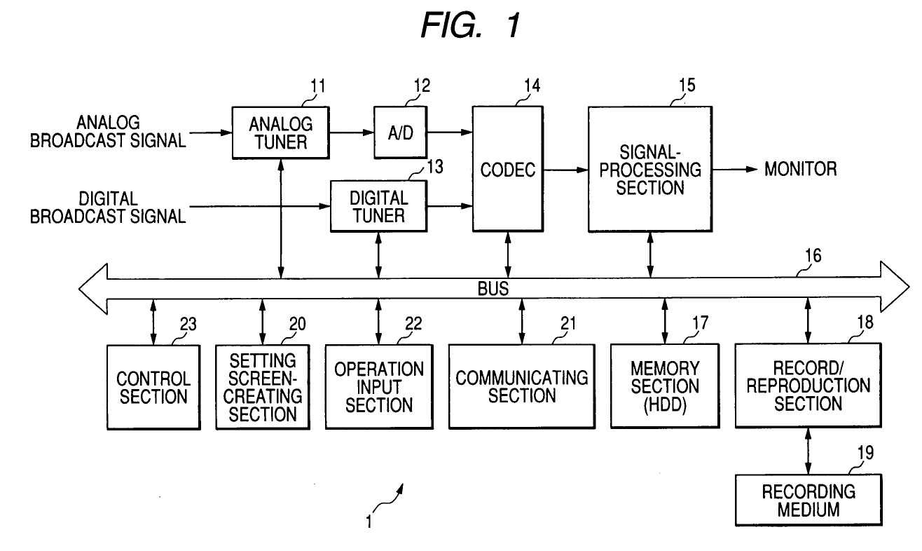

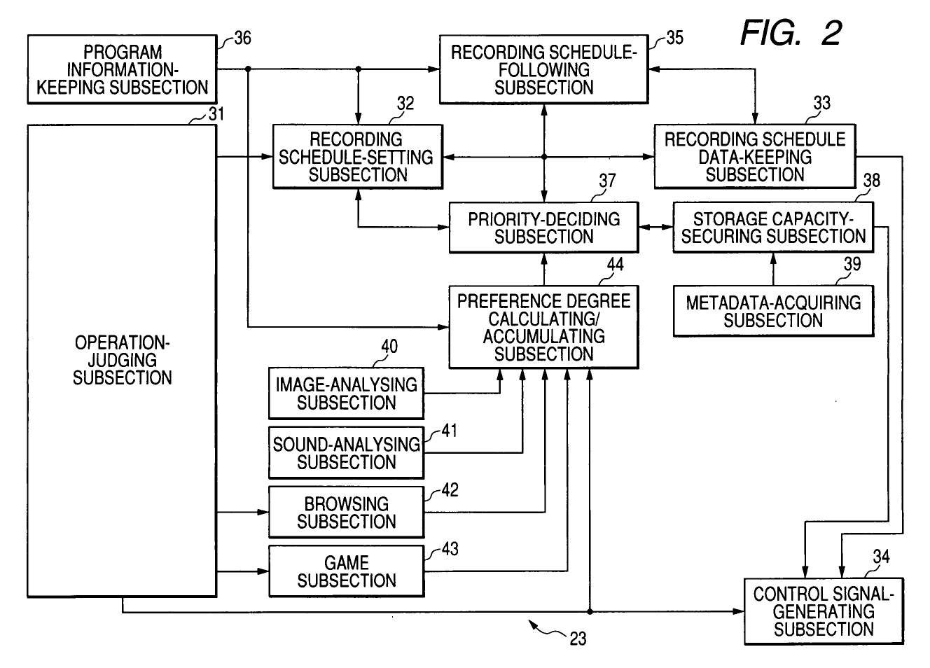

The information processing device (e.g. the video recorder 1 in FIG. 1) according to an embodiment of the present invention includes: a detecting section (e.g. the operation-judging subsection 31 in FIG. 2) operable to detect an instruction provided by the user to execute at least one of a first content including a moving image, a second content including a still image, a third content including a sound, a fourth content including a computer program, and a fifth content including data downloaded through a network; an acquiring section (e.g. the digital tuner 13 in FIG. 1) operable to acquire information on the first to fifth contents according to the instruction detected by the detecting section; and a creating section (e.g. the preference degree calculating/accumulating subsection 44 in FIG. 2) operable to create the information on the user preference based on the information on the first to fifth contents acquired by the acquiring section.

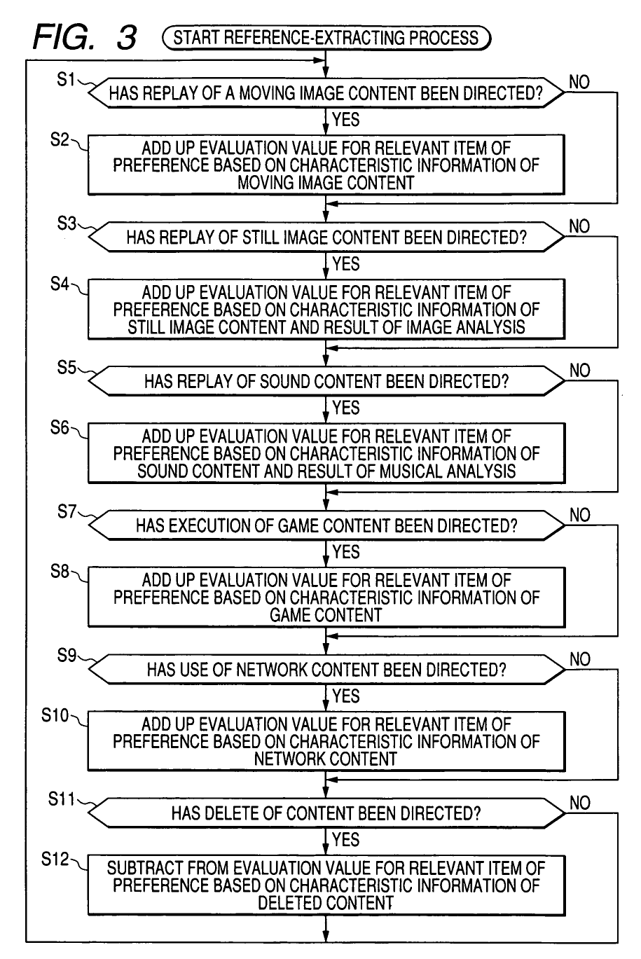

The information processing method according to an embodiment of the invention includes: a detecting step (e.g. Step S1 in FIG. 3) of detecting an instruction provided by the user for execution of at least one of a first content including a moving image, a second content including a still image, a third content including a sound, a fourth content including a computer program, and a fifth content including data downloaded through a network; an acquiring step (e.g. Step S2 in FIG. 3) of acquiring information on the first to fifth contents according to the result of the detection by the detecting step; and a creating step (e.g. Step S2 in FIG. 3) of creating the information on the user preference based on the information on the first to fifth contents acquired by the acquiring step.

The correspondences between the constitutive requirements stated in Claim in association with the program and concrete examples contained in the embodiment of the invention are the same as those described above concerning the information processing method and as such, their description will be omitted here.

Details of specific embodiments that the invention is applied to will be described below with reference to the drawings.

FIG. 1 shows an example of arrangement of a video recorder as an embodiment of the invention. The video recorder 1 is arranged so that it can record a television broadcast program according to a video-recording schedule that has been set, record a radio broadcast program according to a sound-recording schedule that has been set, and receive and record given data, etc. sent by broadcast delivery through a network such as the Internet according to a data-recording schedule that has been set.

Hereinafter these kinds of recording schedules are generically referred to as “recording schedule” inclusively of the sound-recording schedule and data-recording schedule. In addition, pictures and sounds that may be processed by the video recorder 1, such as pictures and sounds of a television program, sounds of a radio program, and given data received through a network, are referred to as contents.

Also, the video recorder 1 is arranged so that it can replay a content accumulated in a memory section 17 and a content recorded on a given recording medium, and output the resulting video and sound signals onto a monitor (not shown) such as a television receiver.

The video recorder 1 is further arranged so as to extract users' preferences based on operations by users. Also, the video recorder is arranged so as to automatically set a recording schedule based on a preference of a user, detect the change in broadcast time of a content, which has been scheduled to be recorded, to change the recording schedule, and secure the capacity of the memory section 17 by deleting a recorded content, moving a recorded content into a recording medium less expensive in unit cost or the like, or compressing a data size thereof through its re-encoding.

In the video recorder 1, an analog tuner 11 receives analog broadcast signals (e.g. ground analog broadcast signals, BS analog broadcast signals, analog CATV broadcast signals, AM radio broadcast signals, FM radio broadcast signals, etc.), and outputs the resulting video and sound signals of a television program or sound signals of a radio program to an analog-to-digital converting section (A/D) 12. Also, the analog tuner 11 receives EPG data contained in analog broadcast signals, and outputs to a control section 23 through a bus 16. The analog-to-digital converting section 12 converts video and sound signals input through the analog tuner 11 into digital signals and outputs to CODEC 14.

A digital tuner 13 receives digital broadcast signals (e.g. ground digital broadcast signals, BS digital broadcast signals, CS digital broadcast signals, digital CATV broadcast signals, etc.), and outputs coded data, which allow the picture and sound of the resulting television program to be reproduced, to CODEC 14 or to the memory section 17 through the bus 16. In addition, the digital tuner 13 receives EPG data included in digital broadcast signals, and outputs to the control section 23 through the bus 16.

In recording, the CODEC 14 codes digital video and sound signals input from the analog-to-digital converting section 12 according to MPEG-2 system or the like, and outputs the resulting coded data through the bus 16 to the memory section 17 or a record/reproduction section 18. Also, in reproduction the CODEC 14 decodes the coded data that have been read out from a recording medium 19 by the memory section 17 or record/reproduction section 18 and input through the bus 16, and outputs the resulting video and sound signals to a signal-processing section 15. The CODEC 14 is capable of: outputting digital video and sound signals input from the analog-to-digital converting section 12 as they are to the signal-processing section 15; decoding coded data input from the digital tuner 13 to output the resulting video and sound signals to the signal-processing section 15; and outputting video and sound signals read out from the recording medium 19 by the record/reproduction section 18 to the signal-processing section 15 as they are.

The CODEC 14 further re-encodes coded data, which have been read out from the memory section 17 and input through the bus 16 thereto for the purpose of ensuring the capacity of the memory section 17, with a higher compression rate, and outputs the resulting coded data with a reduced data size to the memory section 17 through the bus 16.

The signal-processing section 15 carries out a given signal processing on video and sound signals input from the CODEC 14 to output to a monitor such as a television receiver. Also, the signal-processing section 15 carries out a given signal processing on video signals for a setting screen input from a setting screen-creating section 20 to output to the monitor such as a television receiver. The memory section 17 includes e.g. a hard disk drive, and it also stores coded data input from the CODEC 14 through the bus 16, and metadata corresponding to the coded data (characteristic information including a date and time of recording, date and time of last replay, title, cast, genre and broadcast channel, etc.). The memory section 17 stores program data, etc. input from a communicating section 21 through the bus 16. Also, the memory section 17 reads out stored coded data, program data, etc. to output to the CODEC 14 or control section 23 through the bus 16.

A record/reproduction section 18 records coded data input from the CODEC 14, coded data read out from the memory section 17 and input through the bus 16 thereto, etc. on the removable recording medium 19, such as a magnetic disc (including a flexible disc), an optical disc (including a CD-ROM (Compact Disc-Read Only Memory) and a DVD (Digital Versatile Disc)), a magneto-optical disc (including a MD (Mini Disc)), a magnetic tape, or a semiconductor memory. Also, the record/reproduction section 18 reads out coded data recorded on the recording medium 19 to output to the CODEC 14 through the bus 16. Further, the record/reproduction section 18 reads out program data and others recorded on the recording medium 19 to output to the control section 23 through the bus 16.

The setting screen-creating section 20 creates video signals for a setting screen of EPG (Electronic Program Guide) or the like, which will make a user interface for setting a recording schedule, and outputs the signals to the signal-processing section 15 through the bus 16.

The communicating section 21 is connected to a given server through a network (not shown) such as the Internet, and acquires given data (HTML(Hyper Text Markup Language) data, program data, EPG data and the like for displaying a home page). In addition, the communicating section 21 is connected to a given network storage through a network, and transmits coded data and others that are to be moved from the memory section 17 for the purpose of ensuring the capacity of the memory section 17.

An operation input section 22 includes, for example, a remote controller, a button provided on a main body or the like. The operation input section 22 generates an operation signal in response to an operation by a user and outputs to the control section 23 through the bus 16. The control section 23 controls the sections of the video recorder 1 according to the operation signal input from the operation input section 22 through the bus 16.

FIG. 2 shows an example of arrangement of the control section 23 in detail. An operation-judging subsection 31 judges a process corresponding to an operation signal input through the operation input section 22, and controls a relevant portion in order to carry out the judged process.

For example, a recording schedule-setting subsection 32 creates recording schedule data for execution of a schedule for recording a television program, etc. according to an operation signal in response to a user operation to an EPG (Electronic Program Guide), and outputs the data to a recording schedule data-keeping subsection 33. Also, the recording schedule-setting subsection 32 refers to the up-to-date EPG data kept by a program information-keeping subsection 36, thereby to detect e.g. a television program for which a match is found with a search term set by a user or the like, creates recording schedule data to execute a schedule for recording the detected television program or the like, and outputs the data to the recording schedule data-keeping subsection 33.

When the broadcast time shown by the recording schedule data whose creation is attempted overlaps with that shown by the recording schedule data kept by the recording schedule data-keeping subsection 33, the recording schedule-setting subsection 32 appropriately changes the recording schedule data whose creation is attempted and/or already-kept recording schedule data, according to the ranking of priorities resulting from the judgment by a priority-deciding subsection 37. The recording schedule-keeping subsection 33 keeps the recording schedule data created by the recording schedule-setting subsection 32.

A control signal-generating subsection 34 generates a control signal to execute a recording schedule according to recording schedule data kept by the recording schedule-keeping subsection 33 and outputs the signal to a relevant portion of the video recorder 1. Also, the control signal-generating subsection 34 generates a control signal for execution of a process determined by the operation-judging subsection 31, and outputs the signal to a relevant portion of the video recorder 1. Further, the control signal-generating subsection 34 generates a control signal for delete or compression of the coded data, etc. chosen as a disposal target by a storage capacity-securing subsection 38 in the memory section 17 or move thereof from the memory section 17, and outputs the control signal to a relevant portion of the video recorder 1.

A recording schedule-following subsection 35 refers to up-to-date EPG data kept by the program information-keeping subsection 36 thereby to detect the change in broadcast time, etc. of a television program or the like in association with recording schedule data kept by the recording schedule data-keeping subsection 33. According to the detected change of broadcast time, etc., the recording schedule-setting subsection 32 changes the recording schedule data kept by the recording schedule data-keeping subsection 33. In parallel with such change, when an overlap with the broadcast time of a television program or the like shown by other recording schedule data is found, the recording schedule-setting subsection 32 changes the recording schedule data without causing an overlap of broadcast time, according to the ranking of priorities resulting from the judgment by the priority-deciding subsection 37.

The program information-keeping subsection 36 keeps the latest EPG data acquired from broadcast signals or a network. The priority-deciding subsection 37 decides priorities of overlapping recording schedule data based on user preference degrees calculated by a preference degree calculating/accumulating subsection 44. Also, based on user preference degrees calculated by the preference degree calculating/accumulating subsection 44, the priority-deciding subsection 37 decides the priorities to delete, move, and compress coded data stored in the memory section 17.

The storage capacity-securing subsection 38 serves to sense that the unoccupied capacity of the memory section 17 is at or below a given threshold. Then, the storage capacity-securing subsection 38 makes a metadata-acquiring subsection 39 acquire metadata including coded data (characteristic information including a date and time of recording, date and time of last replay, title, cast, genre, broadcast channel, etc.) recorded in the memory section 17, and makes the priority-deciding subsection 37 decide the priorities to delete, move, and compress coded data stored in the memory section 17. Based on the decision, the storage capacity-securing subsection 38 further decides the coded data and others of a disposal target to be deleted or moved out of the memory section 17 or compressed therein.

The metadata-acquiring subsection 39 acquires metadata including coded data stored in the memory section 17 therefrom, and outputs the metadata to the storage capacity-securing subsection 38.

An image-analyzing subsection 40 performs a predetermined process of image analysis on image signals to be processed in the signal-processing section 15, detects features of the image signals (e.g. the tone of a picture, such as a bright picture, dark picture, warm picture, cold picture, etc.), and outputs them to the preference degree calculating/accumulating subsection 44. A sound-analyzing subsection 41 performs a given sound analysis on a sound signal to be processed in the signal-processing section 15, and detects the features of the sound signal (e.g. the tone, rhythm, and tempo of the sound) to output them to the preference degree calculating/accumulating subsection 44.

A browsing subsection 42 is a portion that works as a browser to browse a home page opened on the Internet in response to a user operation. The browsing subsection 42 outputs information on a page that the user is browsing (e.g. URL (Uniform Resource Locator), and the genre, details of the information on the home page on public view) or a search term that the user has entered into a home page for search, etc. to the preference degree calculating/accumulating subsection 44. A game subsection 43 is a portion that makes the video recorder 1 work as a video game machine. The game subsection 43 outputs the information in association with a game that a user played to the preference degree calculating/accumulating subsection 44.

In response to an instruction from a user for watching and/or listening, replay, or delete of a content (a television or radio program on air or recorded, or a picture or musical piece stored in a package medium, such as DVD or CD, data downloaded from a network, or the like), which is entered through the operation-judging subsection 31, the preference degree calculating/accumulating subsection 44 collects the characteristic information on a content targeted for watching and/or listening, replay or delete from EPG data or metadata, or the contents itself to calculate user preference degrees.

For example, the following items may be prepared for the preference degree: a single word contained in a title or the like, a cast (including a singer and a player), a genre, a broadcast channel, a broadcast time zone, picture tone, sound tone, the tempo and rhythm of a music, and the like. When watching and/or listening or replay of a content is directed, the evaluation value of relevant items for the content targeted for the watching and/listening, etc. is incremented. In contrast, when delete of a content is directed, the evaluation value of relevant items for the content targeted for the delete is decremented.

Also, the preference degree calculating/accumulating subsection 44 calculates user preference degrees based on inputs from the image-analyzing subsection 40, sound-analyzing subsection 41, browsing subsection 42, and game subsection 43.

Now, the workings of the video recorder 1 will be described taking as an example a process including the steps, from setting of a recording schedule by a user to recording of a digital television broadcast program according to the schedule.

When a user inputs an operation to set a recording schedule through a screen of an EPG (Electronic Program Guide), etc., which the setting screen-creating section 20 creates, the operation is converted by the operation input section 22 into an operation signal, and then input to the control section 23.

In response to the operation signal, in the control section 23 the operation-judging subsection 31 judges that the user operation is an operation to direct the setting of a recording schedule. Then, the result of the judgment is notified to the recording schedule-setting subsection 32. In the recording schedule-setting subsection 32, recording schedule data according to the user operation is created, and the resulting recording schedule data is kept by the recording schedule data-keeping subsection 33. In the recording schedule data-keeping subsection 33, when the broadcast time of a program to be recorded, which is shown by recording schedule data kept therein, is near at hand, the fact is notified to the control signal-generating subsection 34.

According to the notification, the control signal-generating subsection 34 generates control signals for the digital tuner 13 and memory section 17. In response to the control signal, the digital tuner 13 starts receiving the specified channel and then outputs the resulting coded data to the memory section 17 through the bus 16. In the memory section 17, the input coded data is stored. The description of the workings based on a recording schedule is terminated here.

Next, a user's preference-extracting process by the video recorder 1 will be described with reference to the flow chart of FIG. 3. The preference-extracting process is executed in succession while the power source of the video recorder 1 is in its ON state.

At Step S1, the operation-judging subsection 31 in the control section 23 judges whether or not replay of a moving image content (e.g. a television program on air, a recorded television program, or a moving image content recorded in the memory section 17 or the recording medium 19) has been directed. When it is judged that replay of a moving image content has been directed, the process advances to Step S2. At Step S2, the operation-judging subsection 31 notifies the control signal-generating subsection 34 and the preference degree calculating/accumulating subsection 44 that replay of the moving image content has been directed. According to the notification, the control signal-generating subsection 34 generates a control signal to direct replay of the moving image content, and outputs it to a relevant portion. In addition, according to the notification, the preference degree calculating/accumulating subsection 44 acquires characteristic information of the moving image content whose relay has been directed from EPG data, metadata, etc., and increments the evaluation value of the relevant items in items of a preference by a given value. Incidentally, when it is judged at Step S1 that replay of a moving image content has not been directed, the process skips Step S2.

At Step S3, the operation-judging subsection 31 in the control section 23 judges whether or not replay of a still image content (e.g. a still image content recording in the memory section 17 or recording medium 19 or the like) has been directed. When it is judged that replay of a still image content has been directed, the process advances to Step S4. At Step S4, the operation-judging subsection 31 notifies the control signal-generating subsection 34 and the preference degree calculating/accumulating subsection 44 that replay of the still image content has been directed. According to the notification, the control signal-generating subsection 34 generates a control signal to direct replay of the still image content and outputs it to a relevant portion. In addition, according to the notification, the preference degree calculating/accumulating subsection 44 acquires characteristic information of the still image content whose replay has been directed from metadata, etc. and increments the evaluation value of the relevant items in items of a preference by the given value. Further, the preference degree calculating/accumulating subsection 44 increments the evaluation value of the relevant items in items of a preference by the given value according to the result of image analysis that is input from the image-analyzing subsection 40. Incidentally, when it is judged at Step S3 that replay of a still image content has not been directed, the process skips Step S4.

At Step S5, the operation-judging subsection 31 in the control section 23 judges whether or not replay of a sound content (e.g. a radio program on air or recorded, or a sound content recorded in the memory section 17, recording medium 19, or a package medium) has been directed. When it is judged that replay of a sound content has been directed, the process advances to Step S6. At Step S6, the operation-judging subsection 31 notifies the control signal-generating subsection 34 and the preference degree calculating/accumulating subsection 44 that replay of the sound content has been directed. According to the notification, the control signal-generating subsection 34 generates a control signal to direct replay of the sound content, and outputs it to a relevant portion. In addition, according to the notification, the preference degree calculating/accumulating subsection 44 acquires characteristic information of the sound content whose replay has been directed from EPG data, metadata, etc. and increments the evaluation value of the relevant items in items of a preference by the given value. Further, the preference degree calculating/accumulating subsection 44 increments the evaluation value of the relevant items in items of a preference by the given value according to the result of sound analysis that is input from the sound-analyzing subsection 41. Incidentally, when it is judged at Step S5 that replay of a sound content has not been directed, the process skips Step S6.

At Step S7, the operation-judging subsection 31 in the control section 23 judges whether or not execution of a game content (e.g. a program for a game recorded in the memory section 17 or the recording medium 19) has been directed. When it is judged that execution of a game content has been directed, the process advances to Step S8. At Step S8, the operation-judging subsection 31 notifies the game subsection 43 that execution of the game content has been directed. In response to the notification, the game subsection 43 executes the game content and concurrently notifies the preference degree calculating/accumulating subsection 44 of the information on the executed game content. On the notification, the preference degree calculating/accumulating subsection 44 increments the evaluation value of the relevant items in items of a preference by the given value. Incidentally, when it is judged at Step S7 that execution of a game content has not been directed, the process skips Step S8.

At Step S9, the operation-judging subsection 31 in the control section 23 judges whether or not use of a network content (e.g. browsing of a home page opened on the Internet, or use of a search engine) has been directed. When it is judged that use of a network content has been directed, the process advances to Step S10. At Step S10, the operation-judging subsection 31 notifies the browsing subsection 42 that use of the network content has been directed. In response to the notification, the browsing subsection 42 starts use of the directed network content, and concurrently notifies the preference degree calculating/accumulating subsection 44 of the information on the used network content (the genre and search term of the home page, etc.). On the notification, the preference degree calculating/accumulating subsection 44 increments the evaluation value of the relevant items in items of a preference by the given value. Incidentally, when it is judged at Step S9 that use of a network content has not been directed, the process skips Step S10.

At Step S11, the operation-judging subsection 31 in the control section 23 judges whether or not delete of a content (a moving image content, a still image content, a sound content or a game content as above described, or the like) from the memory section 17 or the recording medium 19 has been directed. When it is judged that delete of a content has been directed, the process advances to Step S12. At Step S12, the operation-judging subsection 31 notifies the preference degree calculating/accumulating subsection 44 that delete of the content has been directed. According to the notification, the preference degree calculating/accumulating subsection 44 acquires characteristic information of the content whose delete has been directed from EPG data, metadata, etc. and decrements the evaluation value of the relevant items in items of a preference by the given value. Incidentally, when it is judged at Step S11 that delete of a content has not been directed, the process skips Step S12. Then, the process is returned to Step S1, and the steps after that are repeated.

As described above, the preference-extracting process enables the extraction of a user preference even with a user watching and/or listening to a television program at a low frequency because the process includes calculating a preference of a user based on instructions of the user to various contents and accumulating the result.

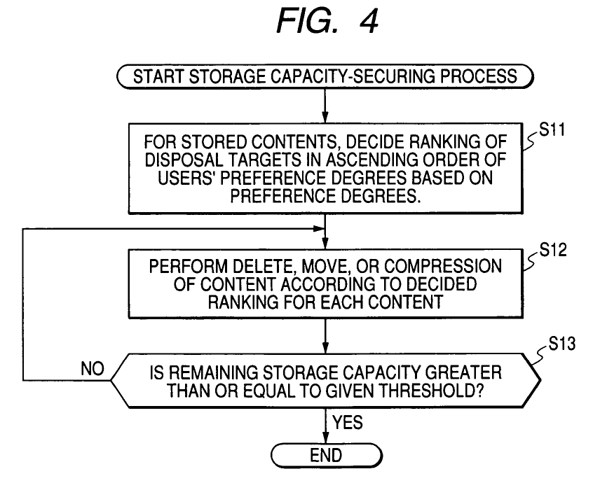

Next, a process to secure the unoccupied capacity of the memory section 17 (hereinafter cited as “storage capacity-securing process”) will be described with reference to the flow chart of FIG. 4. The storage capacity-securing process is started when the storage capacity-securing subsection 38 senses that the unoccupied capacity of the memory section 17 is at or below a given threshold.

At Step S1, the storage capacity-securing subsection 38 requests the metadata-acquiring subsection 39 to acquire the metadata (characteristic information including date and time of recording, date and time of last replay, title, cast, genre and broadcast channel) of a content recorded by automatic recording of contents recorded in the memory section 17. According to the request, the metadata-acquiring subsection 39 acquires the metadata of an adequate content recorded in the memory section 17 and supplies it to the storage capacity-securing subsection 38. The storage capacity-securing subsection 38 outputs the metadata of a content recorded in the memory section 17 to the priority-deciding subsection 37, in which the content is supplied from the metadata-acquiring subsection 39. The priority-deciding subsection 37 refers to user preference degrees accumulated in the preference degree calculating/accumulating subsection 44, thereby to decide the ranking of disposal targets of contents recorded in the memory section 17 in ascending order of user preference degrees.

At Step S12, the storage capacity-securing subsection 38 decides one content as a disposal target, which is to be deleted or moved from the memory section 17, or compressed therein, according to the ranking of disposal targets decided by the priority-deciding subsection 37. Then, the storage capacity-securing subsection notifies the result of the decision to the control signal-generating subsection 34. According to the decision, the control signal-generating subsection 34 outputs a control signal to delete or move the content decided on as a disposal target from the memory section 17 or to compress it to a relevant portion. According to the control signal, the content decided on as a disposal target is to be deleted or moved from the memory section 17, or compressed in its data size by re-encoding.

At Step S13, the storage capacity-securing subsection 38 judges whether or not the unoccupied capacity of the memory section 17 exceeds a given threshold. The process is returned to Step S12 and the steps after that are repeated until it is judged that the unoccupied capacity of the memory section 17 exceeds the given threshold. When it is judged at Step S13 that the unoccupied capacity of the memory section 17 exceeds the given threshold, the storage capacity-securing process is terminated.

The above-described storage capacity-securing process allows contents to be deleted from the memory section 17, to be moved to the recording medium 19 less expensive in unit cost, or to be compressed in its data size by re-encoding in order from a content that is the lowest in user preference degrees regardless of the date and time of recording and last replay. Therefore, even with a content that is old in date and time of recording or last replay, when it is inferred that a user is interested in the content, it becomes possible to secure the capacity of the memory section 17 while keeping the content, in which there is no need for a special setting by the user (e.g. setting to prevent the particular content from being targeted for delete).

Now, the outline of a process to change recording schedule data in response to the change in broadcast time of a program whose recording schedule has been set or the like (hereinafter cited as “recording schedule-following process”) will be described. The video recorder 1 has a recording schedule that is set by a user (hereinafter cited as “user recording schedule”), and a recording schedule that is automatically set based on preference degrees of the user (hereinafter cited as “automatically recording schedule”). Of these, the video recorder is arranged so that a user can set whether or not to execute the recording schedule-following process on the user recording schedule.

In the course of execution of the recording schedule-following process, the priorities in the case where the broadcast time overlaps that of some other recording schedule are in descending order as follows: a user recording schedule with a setting in which the recording schedule-following process is not executed; a user recording schedule with a setting in which the recording schedule-following process is executed and with no change in broadcast time; a user recording schedule with a setting in which the recording schedule-following process is executed and with a change in broadcast time; an extension of relay broadcasting of a game of e.g. baseball; and automatically recording schedule.

When in a recording schedule pair (composed of two or more recording schedules) in which the recording schedules overlap in broadcast time (recording time), the priorities are identical among the schedules, the recording schedule that the larger evaluation value belongs to (i.e. the recording schedule that the user is more interested in) takes higher priority in consideration of the evaluation values based on user preference degrees for each recording schedule.

When in a recording schedule pair in which the recording schedules overlap in broadcast time, the priorities are identical among the schedules, and the evaluation values based on user preference degrees for the recording schedules are identical, the recording schedule having an earlier airing start time takes higher priority. In addition, in the case where the airing start times are also identical, the recording schedule that is smaller in broadcast channel number takes higher priority.

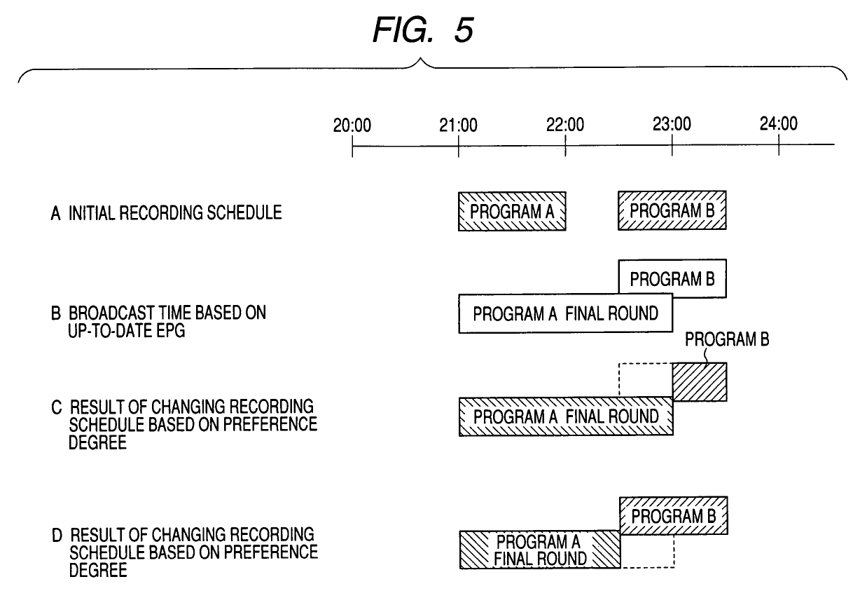

For example, the following case is assumed: it was detected that of Program A (scheduled to be broadcasted from 21:00 to 22:00) and Program B (scheduled to be broadcasted from 22:30 to 23:30), which did not overlap in broadcast time in the initial recording schedules as shown in FIG. 5A, the broadcast time of Program A was prolonged according to the up-to-date EPG data because of its final round thereby to be turned into 21:00 to 23:00, as shown in FIG. 5B.

In this case, if Program A has higher priority, the initial two pieces of recording schedule data are changed so that Program A is recorded from 21:00 to 23:00 and Program B is recorded from 23:00 to 23:30 as shown by hatched areas in FIG. 5C.

In contrast, if Program B has higher priority, the initial two pieces of recording schedule data are changed so that Program A is recorded from 21:00 to 22:30 and Program B is recorded from 22:30 to 23:30 as shown by hatched areas in FIG. 5D.

In other words, the recording schedule-following process is arranged so that in a recording schedule pair in which the recording schedules overlap in broadcast time, even the recording schedule data having lower priority is not simply rejected, and it is recorded as far as possible even thought it is difficult to record the entire program.

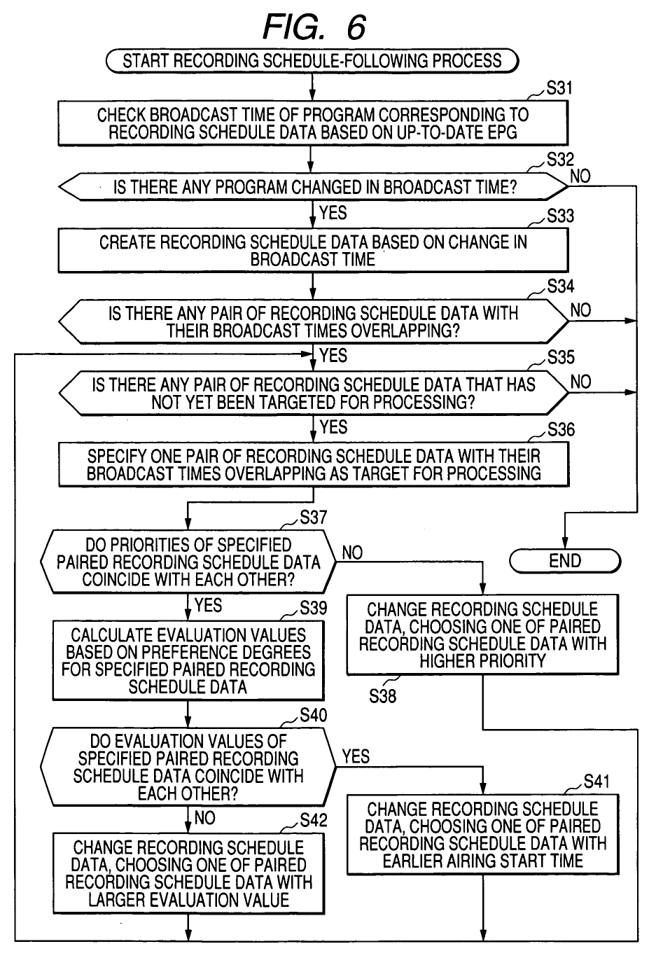

FIG. 6 is a flow chart of assistance in explaining the recording schedule-following process. The recording schedule-following process is executed, for example, when EPG data is acquired, when a setting of time is changed, or a recording schedule is added, changed or deleted.

At Step S31, the recording schedule-following subsection 35 refers to the up-to-date EPG data kept by the program information-keeping subsection 36 thereby to check the broadcast times of programs shown by recording schedule data kept by the recording schedule data-keeping subsection 33. At Step S32, the recording schedule-following subsection 35 judges whether or not in user recording schedules for which the setting to execute the recording schedule-following process has been made, there is the user recording schedule with its broadcast time (i.e. recording time) different from that shown by the up-to-date EPG data checked in the process at Step S31. That is, the recording schedule-following subsection 35 judges whether or not there is user recording schedule data for which the setting to execute the recording schedule-following process has been made and the change in broadcast time has been made. When it is judged that there is recording schedule data changed in its broadcast time, the process advances to Step S33. In contrast, when it is judged at Step S32 that there is no recording schedule data changed in its broadcast time, the recording schedule-following process is terminated. At Step S33, the recording schedule-setting subsection 32 creates new recording schedule data for the changed broadcast time.

At Step S34, the recording schedule-following subsection 35 judges whether or not in pieces of recording schedule data kept by the recording schedule data-keeping subsection 33 and the recording schedule data created at Step S33, there is a combination of recording schedule data overlapping in broadcast time (recording time). When it is judged that there is not such combination of recording schedule data, the recording schedule data created at Step S33 is kept by the recording schedule data-keeping subsection 33 and then the recording schedule-following process is terminated.

When it is judged at Step S34 that in pieces of recording schedule data kept by the recording schedule data-keeping subsection 33 and the recording schedule data created at Step S33, there is a combination of recording schedule data overlapping in broadcast time (recording time), the process advances to Step S35. Hereinafter, the pieces of recording schedule data overlapping in broadcast time (recording time) are cited as a recording schedule data pair.

At Step S35, the recording schedule-following subsection 35 judges whether or not, of such recording schedule data pairs, there is a recording schedule data pair that has not been specified as a target to be processed. When it is judged that there is a recording schedule data pair that has not been specified as a target to be processed, at Step S36 the recording schedule data pair that has not been specified as a target to be processed is specified as a target to be processed.

At Step S37, the recording schedule-following subsection 35 judges whether or not the priorities of recording schedule data that constitute a recording schedule data pair specified as a target to be processed are identical (in which the priorities depend on: a user recording schedule for which the setting not to execute the recording schedule-following process has been made; a user recording schedule for which the setting to execute the recording schedule-following process has been made and no change in broadcast time has been made; a user recording schedule for which the setting to execute the recording schedule-following process has been made and the change in broadcast time has been made; an extension of relay broadcasting of a game of e.g. baseball; and whether or not automatically recording schedule has been made). When it is judged that the priorities of recording schedule data that constitute a recording schedule data pair specified as a target to be processed are not identical, the process advances to Step S38. At Step S38, the recording schedule-setting subsection 32 changes the recording schedule data kept in the recording schedule data-keeping subsection 33 according to the priorities of recording schedule data that constitute a recording schedule data pair specified as a target to be processed. Then, the process is returned to Step S35, and the steps after that are repeated.

In contrast, when it is judged at Step S37 that the priorities of recording schedule data that constitute a recording schedule data pair specified as a target to be processed are identical, the process advances to Step S39. At Step S39, the recording schedule-following subsection 35 acquires the characteristic information on the recording schedule data that constitute a recording schedule data pair specified as a target to be processed from EPG data kept in the program information-keeping subsection 36 to output the information to the priority-deciding subsection 37. The priority-deciding subsection 37 refers to the user preference degrees accumulated in the preference degree calculating/accumulating subsection 44, calculates the evaluation values showing the extent to which the recording schedule data constituting a recording schedule data pair specified as a target to be processed meet preferences of the user, and outputs them to the recording schedule-following subsection 35.

At Step S40, the recording schedule-following subsection 35 judges whether or not the evaluation values, which result from the calculations on the recording schedule data constituting a recording schedule data pair specified as a target to be processed in the process at Step S39, are identical. When it is judged that the evaluation value resulting from the calculations on the recording schedule data are identical, the process advances to Step S41. At Step S41, the recording schedule-setting subsection 32 gives higher priority to one piece of the recording schedule data constituting a recording schedule data pair specified as a target to be processed, which an earlier airing start time belongs to, and changes the recording schedule data kept in the recording schedule data-keeping subsection 33. Incidentally, when the airing start times of the recording schedule data constituting a recording schedule data pair specified as a target to be processed are identical, one piece of the recording schedule data, which has a smaller broadcast channel number, takes higher priority to change the recording schedule data kept in the recording schedule data-keeping subsection 33. Then, the step is returned to Step S35, and the steps after that are repeated.

When it is judged at Step S40 that the evaluation values resulting from the calculations on the recording schedule data are not identical, the process advances to Step S42. At Step S42, the recording schedule-setting subsection 32 changes the recording schedule data kept in the recording schedule data-keeping subsection 33, according to the evaluation values on the recording schedule data constituting a recording schedule data pair specified as a target to be processed.

Thereafter, the process is returned to Step S35. Then, the steps after that are repeated until it is judged at Step S35 that recording schedule data pairs contain no recording schedule data pair that has not yet been specified as a target to be process. When it is judged that the recording schedule data pairs contain no recording schedule data pair that has not yet been specified as a target to be processed, the recording schedule-following process is terminated.

According to the above-described recording schedule-following process, when the recording schedules overlap, a preference of a user is reflected to change the recording schedule. Therefore, it becomes possible to give higher priority to and record a program that the user can be presumed to prefer watching and/or listening to.

In the above description on the recording schedule-following process, two recording schedules that overlap in broadcast time has been described. However, the recording schedule-following process can be applied to the case where the priorities of three or more recording schedules that overlap in broadcast time are decided to change the recording schedules appropriately.

The recording schedule-following process can be applied to not only the case of scheduling a television program to be recorded but also the case of recording a program, which is to be sent by delivery through CATV or radio broadcast or the Internet, according to a schedule.

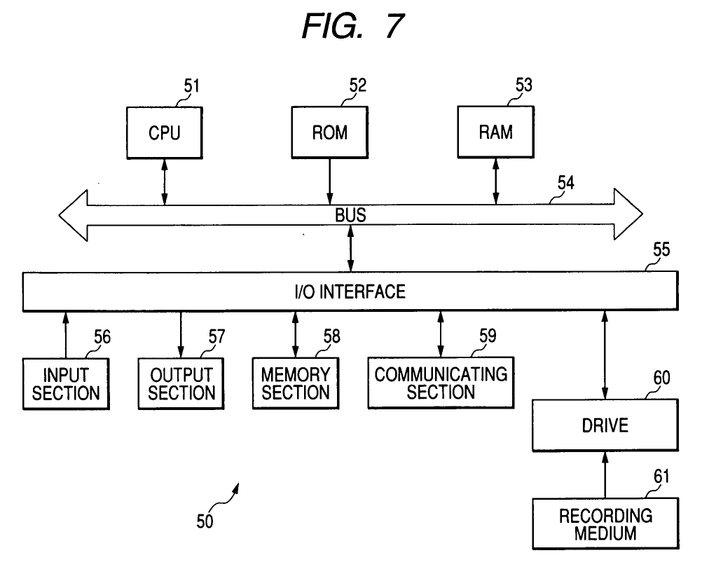

Now, a series of the processes described above can be carried by hardware, but they may be carried out by software. When the series of the processes are executed by software, the programs constituting the software are installed from a recording medium to a computer incorporated in a dedicated piece of hardware, a general purpose personal computer, for example, as shown in FIG. 7 or the like, which is allowed to execute various functions when the various programs are installed thereto.

The personal computer 50 has a CPU (Central Processing Unit) 51 incorporated therein. To the CPU 51 is connected an Input/Output (I/O) interface 55 through a bus 54. To the bus 54 are connected a ROM (Read Only Memory) 52 and a RAM (Random Access Memory) 53.

To the I/O interface 55 are connected: an input section 56 including any of input devices, e.g. a keyboard and a mouse, through which a user inputs an operation command; an output section 57 including a display apparatus to display combined video signals, such as a CRT (Cathode Ray Tube) or LCD (Liquid Crystal Display); a memory section 58 to hold a program and various kinds of data, including a hard disk drive; and a communicating section 59 to execute a communication process through a network typified by the Internet, including a modem and a LAN (Local Area Network) adaptor. Also, to the I/O interface 55 is connected a drive 60, which reads out data from a recording medium 61 and writes data thereon, such as a magnetic disc (including a flexible disc), an optical disc (including a CD-ROM(Compact Disc-Read Only Memory), and a DVD (Digital Versatile Disc)), a magneto-optical disc (including a MD(Mini Disc)), or a semiconductor memory.

The program to make the personal computer 50 execute the series of the processes described above is supplied to the personal computer 50 in the condition where it held by the recording medium 61. Then, the program is read out from the recording medium by the drive 60 and installed on the hard disk drive incorporated to the memory section 58. The program installed on the memory section 58 is loaded onto RAM 53 from the memory section 58 and executed according to an instruction from CPU 51 in response to a command from a user that is input through the input section 56.

Herein, though the steps executed based on the program shall include not only the processes that are carried out in time sequence according to the described order, but also processes to be executed in parallel or separately, which may not have to be necessarily conducted in time sequence.

In addition, the program may be handled by a single computer, or may undergo distributed processing by a plurality of computers. Further, the program may be transmitted to a remote computer and executed there.

It should be understood by those skilled in the art that various modifications, combinations, sub-combinations and alterations may occur depending on design requirements and other factors insofar as they are within the scope of the appended claims or the equivalents thereof.

1. An information processing device operable to create information on the preference of a user, comprising:
a detecting section operable to detect an instruction provided by the user to execute at least one of a first content including a moving image, a second content including a still image, a third content including a sound, a fourth content including a computer program, and a fifth content including data downloaded through a network;
an acquiring section operable to acquire information on the first to fifth contents according to the instruction detected by the detecting section; and
a creating section operable to create information on a user preference based on the information on the first to fifth contents acquired by the acquiring section.

2. The information processing device of claim 1, further comprising a setting section operable to automatically set a recording schedule based on the information on the user preference created by the creating section.

3. The information processing device of claim 1, wherein the detecting section is further operable to detect an instruction provided by the user to delete at least one of the first to fifth contents.

4. The information processing device of claim 3, wherein when the detecting section detects the delete instruction, the creating section counts down an evaluation value of an item in association with the at least one deleted content and creates the information on the user preference.

5. The information processing device of claim 1, wherein when the detecting section detects an instruction provided by the user to watch and/or listen to or replay the at least one of the first to fifth contents, the creating section adds up an evaluation value of an item in association with the at least one content and creates the information on the user preference.

6. An information processing method for creating information on the preference of a user, comprising:
detecting an instruction provided by the user to execute at least one of a first content including a moving image, a second content including a still image, a third content including a sound, a fourth content including a computer program, and a fifth content including data downloaded through a network;
acquiring information on the first to fifth contents according to the detected instruction; and
creating information on a user preference based on the information on the first to fifth contents acquired.

7. A recording medium recorded with a computer program for executing an information processing method for creating information on the preference of a user, the method comprising:
detecting an instruction provided by the user to execute at least one of a first content including a moving image, a second content including a still image, a third content including a sound, a fourth content including a computer program, and a fifth content including data downloaded through a network;
acquiring information on the first to fifth contents according to the detected instruction; and
creating information on a user preference based on the information on the first to fifth contents acquired.
